(19) United States
(12) Patent Application Publication
(10) Pub. No.: US 2012/0245988 A1
(43) Pub. Date: Sep. 27, 2012

(54) DYNAMIC BUNDLING SYSTEMS AND METHODS

(75) Inventors: Michael Pace, Maple Valley, WA (US); Lee Fergestrom, Sammamish, WA (US); John Hardi, Sammamish, WA (US); Chris Sager, Bellevue, WA (US); Edward Cerruti, Bellevue, WA (US); Naomi Williams, Durham, NC (US)

(73) Assignee: MOTRICITY, INC., Bellevue, WA (US)

(21) Appl. No.: 13/052,929

(22) Filed: Mar. 21, 2011

(51) Int. Cl. G06Q 30/02

(52) U.S. Cl. 705/14.25; 705/14.1

(57) ABSTRACT

Techniques for bundle generation are described. Some embodiments include a mobile marketplace system (“MMS”) configured to provide dynamically generated content bundles to users in a mobile marketplace. Providing a dynamically generated content bundle may include generating a content bundle that includes multiple related content items, such as songs, ringtones, images, videos, or the like. Some embodiments generate linked bundles that include content items that share one or more attributes, such as artist, genre, or content provider. In other embodiments, content bundles may be generated based on activities of one or more users, including purchase or browsing history. The MMS may also determine a discounted price for a generated content bundle based on pricing information associated with the content items of the bundle. In addition, the MMS may assure compliance with license terms or other safeguards associated with content items.

### FIELD OF THE INVENTION

The field of the invention is electronic marketplaces, and more particularly facilitating distribution of dynamically generated bundles to users of mobile devices.

### BRIEF DESCRIPTION OF THE DRAWINGS

Preferred and alternative examples of the present invention are described in detail below with reference to the following drawings:

FIG. 1 is an example block diagram of an embodiment of a mobile marketplace system.

FIGS. 2A-2D illustrate mobile device screen displays provided by an example embodiment.

FIGS. 3A-3C illustrate data processed, utilized, or generated by an example embodiment.

FIG. 4 is a block diagram of a computing system for implementing a mobile marketplace system according to an example embodiment.

FIG. 5 is a flow diagram of a bundling process performed in an example embodiment.

### DETAILED DESCRIPTION

Embodiments described herein provide enhanced computer- and network-based methods and systems for dynamically generating and distributing bundles of related products or services for purchase, access, or use on mobile devices and/or other computing systems. Bundled products may include tangible items, such as clothing, books, personal electronics, toys, and the like. Products may also or instead include content items or other information goods, such as music, videos, electronic books, and the like. Bundled services may include acts or functions performed for the benefit of another, such as travel services, banking services, real estate services, and the like.

Example embodiments include a mobile marketplace system (“MMS”) configured to provide a marketplace for content items that are available for purchase or other access via mobile devices. In one embodiment, the MMS generates and distributes content bundles that each includes multiple related content items, such as ringtones, music, videos, or the like. For example, a content bundle may include multiple content items from or about a single artist, such as a song by the artist, a ringtone from the artist, an image of the artist, and a music video featuring the artist. Content bundles may be generated in various ways and based on various types or sources of information. For example, content bundle generation may be based on attributes or information associated with content items, such as artist name, genre, type (e.g., song, album, ringtone), provider (e.g., publisher, label), or the like. Content bundle generation may also or instead be based on information about one or more users, such that generated content bundles can include items that are relevant to a user based on the past purchase history of that user and/or other users. Additional details and techniques for content bundle generation will be provided below.

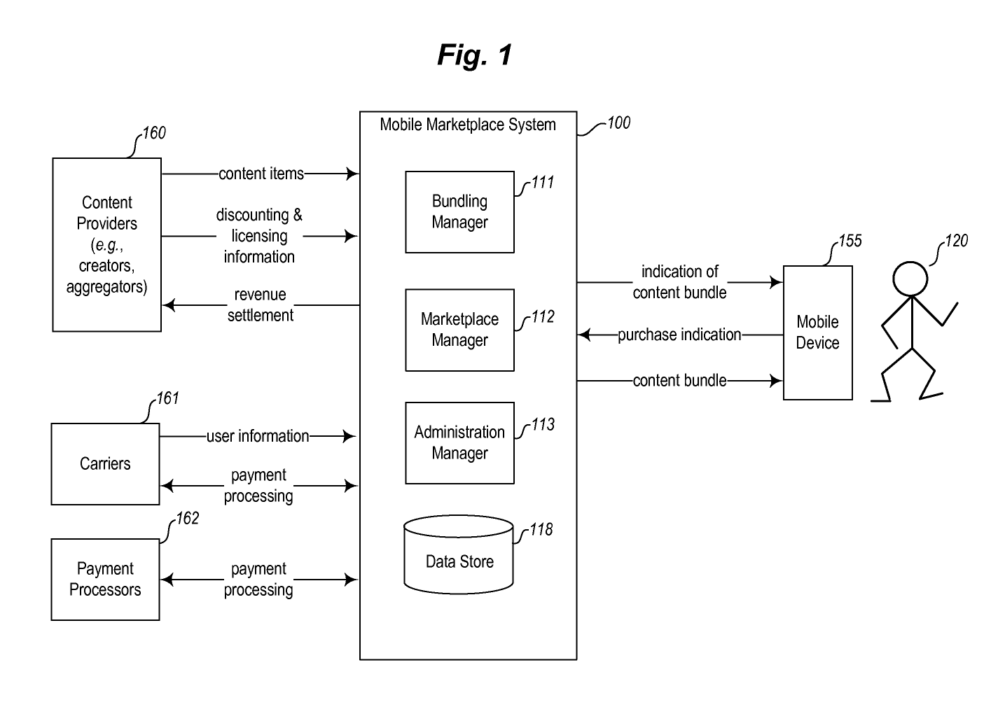

FIG. 1 is a block diagram of an example embodiment of a mobile marketplace system. In particular, FIG. 1 illustrates a mobile marketplace system (“MMS”) 100 that includes a bundling manager 111, a marketplace manager 112, an administration manager 113, and a data store 118. The MMS 100 provides a mobile marketplace to a user 120 operating a client device 155. The client device 155 will preferably be a mobile device, and will be referred to herein as a mobile device, but may be any type of device facilitating communication between the user 120 and the MMS 100. In addition, the MMS 100 interacts with content providers 160 (e.g., content creators, publishers, aggregators), carriers 161 (e.g., telecom or cellular carriers), and payment processors 162 (e.g., credit card payment processors, banks, Internet payment services).

The bundling manager 111 generates content bundles that are to be made available via the MMS 100 for purchase by the user 120 via the mobile device 155. Generating a content bundle may include receiving content items (or information about content items) from one or more content providers 160. These content items may be stored locally, such as in the data store 118, or remotely, such as by the content providers 160. Multiple techniques for bundling are contemplated, including (1) based on content item attributes (sometimes referred to as “linked” bundling), (2) based on user activities (sometimes referred to as “relevancy” bundling), and/or (3) manually (sometimes referred to as “editorial” bundling). Each of these techniques is discussed in more detail below, and although they are described separately they may be combined in various ways by other embodiments. Generated content bundles (or indications thereof) may be stored in the data store 118 for provision to users via the marketplace manager 112, as discussed below.

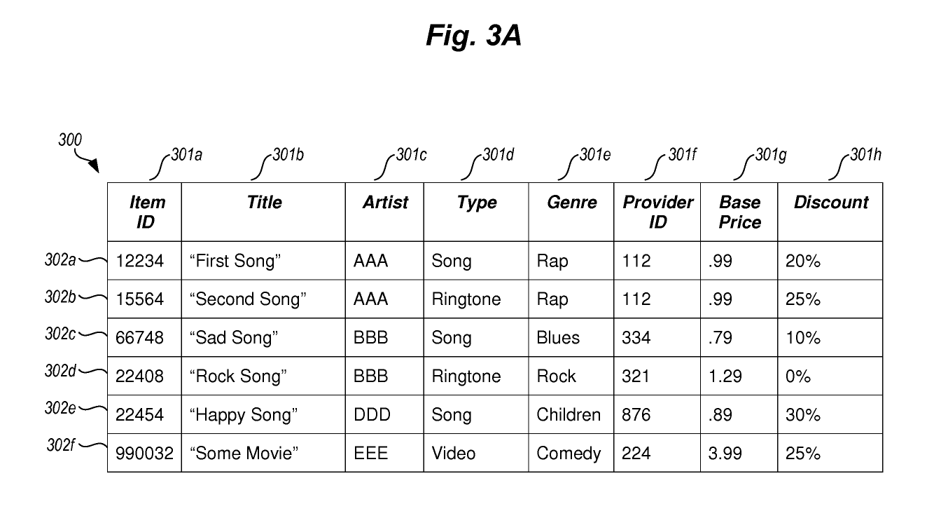

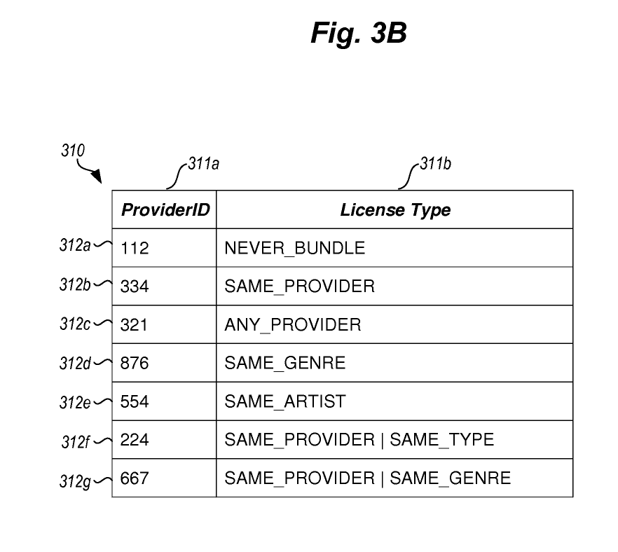

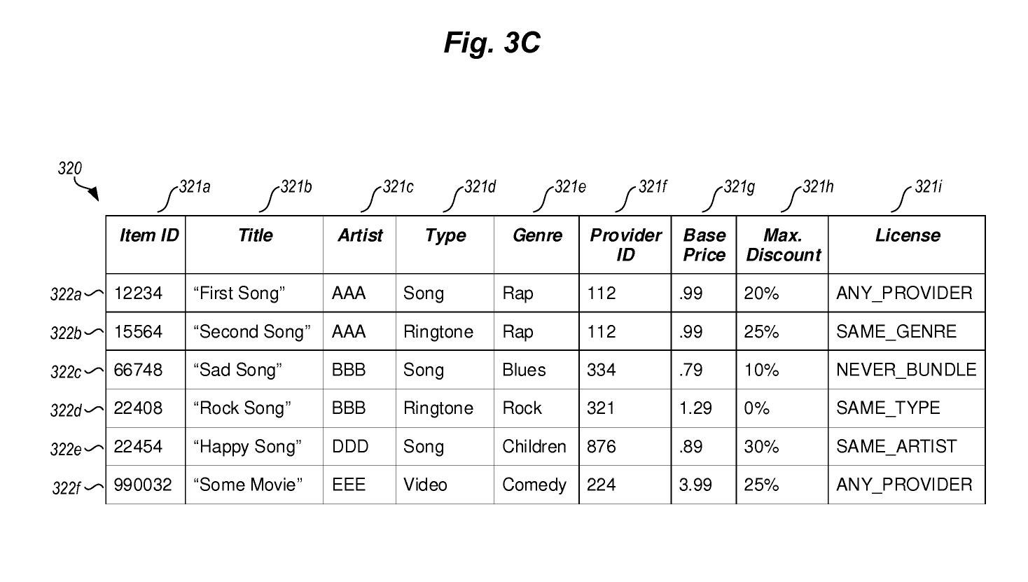

Linked content bundles may be generated based on content item attributes such as artist, genre, content item type, content provider and the like. For example, the bundling manager 111 may automatically generate bundles of content items that have the same artist or genre. In other embodiments, an ISRC (“International Standard Recording Code”) or similar identifier can be used to generate linked bundles. The ISRCs (or similar) associated with content items include or reference information (e.g., artist, publisher, recording, country) that may be used to generate content bundles. For example, a full-length song by artist X may have the same ISRC as the ringtone of that song. In such cases, the bundling manager 111 can be configured to identify and bundle content items with the same ISRC. Examples of linked bundling and content item attributes are provided and described further with respect to FIGS. 3A and 3C, below.

Relevancy-based content bundles may be generated based on information about the user 120, including past activities of the user 120 and/or other users. In one embodiment, the bundling manager 111 may generate and recommend bundles based on past purchase activities of other users. For example, if the user 120 indicates a desire to purchase content item X, the bundling manager 111 may identify one or more other content items (e.g., Y and Z) that were bought by other users who also bought content item X. Then, the bundling manager 111 can provide (e.g., recommend) a content bundle containing items X, Y, and Z to the user. Various techniques can be employed to generate relevancy-based bundles, including recommendation or filtering techniques that utilize cosine similarity, Bayesian networks, cluster analysis or related techniques to identify co-occurrences, cluster data, or otherwise detect patterns that can be used to determine suitable candidates for inclusion in a content bundle.

Editorial bundles may be generated by human editors or other users that manually select content items that are related (e.g., hard rock bundles) or that may be grouped together for marketing or other reasons. For example, human editors may create song bundles based on “top ten” or favorite song lists obtained from featured celebrities, sports stars, or the like. The bundling manager 111 may facilitate such activities by indexing generated bundles, causing editors to review existing bundles (e.g., by providing lists of bundles that are older than a specified date or that are not selling well), automatically deleting old or poorly selling bundles, and the like.

Bundles may also or instead be generated based on other kinds of information, such as attributes or other characteristics of the user and/or his device. For example, a content item may be selected for inclusion in a content bundle based on the characteristics of a mobile device (e.g., display resolution, CPU speed), so that the content item can be presented on the mobile device with a minimum of conversion or other data manipulation (e.g., image scaling, audio conversion). In another embodiment, a content item may be selected for inclusion in a content bundle based on demographic information about the user. For example, different bundles may be generated based on the age, gender, location, or income of the user.

Generating a content bundle may also include automatically determining a price for the content bundle. In some embodiments, the bundling manager 111 stores pricing and/or discounting information that is associated with content items and/or the content providers 160. For example, pricing information may specify how much (if any) discount is to be applied to the base price of a content item when the item is included in a bundle. The bundling manager 111 can then utilize the pricing information to automatically determine a price for a content bundle that is less than the sum of the prices of the individual content items in the bundle. The bundling manager 111 may also take into consideration other factors, such as whether a particular bundle is selling well, and if not, reducing the price of the bundle for future offers; whether a user is a high-volume consumer, and if so, reducing the price of bundles offered to that user as a reward for being a good customer; whether the user is a new user, and if so, setting a reduced “introductory” price for a bundle offered to that user. Examples of price determination and information are provided and described further with respect to FIGS. 3A and 3C.

Generating a content bundle may also include assuring compliance with license terms, safeguards, or other licensing-related information associated with one or more content items of the bundle. In certain embodiments, the bundling manager 111 associates license terms with content items and/or content providers 160. The license terms may indicate or specify conditions under which content items may be included in a bundle. For example, a content item may have license terms that specify that it can only be bundled under certain conditions or in certain ways, such as one or more of: with other content items from the artist that recorded the content item, with content items of the same genre, with content items provided by the same content provider, or the like. Examples of license compliance and license terms are provided and described further with respect to FIGS. 3B and 3C.

The marketplace manager 112 generally performs user-accessible functions for or on behalf of the user 120 operating the mobile device 155. In one embodiment, the marketplace manager 112 provides an online store or shopping facility for the user 120. Generally, providing on online store may include providing information about products or services (e.g., via browsing and/or search) that are available via the mobile marketplace, and facilitating payments for those products or services. With regard to content bundles, the marketplace manager 112 receives, such as directly from the bundling manager 111 or the data store 118, information about content bundles that are available for purchase. Then, the marketplace manager 112 transmits to the mobile device 155 indications of content bundles along with pricing and/or other information (e.g., licensing terms or duration). The marketplace manager 112 may also provide search facilities, such that the user 120 can submit searches for available content bundles or other items. The marketplace manager 112 further facilitates transactions for purchased content bundles, for example by receiving an indication of a content bundle that the user 120 wishes to purchase, and then interacting with carriers 161 or payment processors 162 to obtain a payment from the user 120. Upon processing payment for a content bundle, the marketplace manager 112 provides (e.g., sends, transmits, dispatches) the content bundle to the mobile device 155, where it can accessed by the user 120. Also, after receiving payment for a content bundle, the marketplace manager 112 settles revenue between possibly multiple distinct content providers that provided content items included in the bundle. For example, the marketplace manager 112 may provide payments to various content providers on a daily, weekly, or monthly basis based on the number, price, and source of content items included in sold content bundles.

The administration manager 113 generally performs administrative functions related to the operation of the mobile marketplace system 100. Such functions may include user management, content management, catalog management, merchandising, and the like. With respect to content bundling, the administration manager 113 provides a control or configuration facility by which content providers or other parties can specify license terms, control bundle generation and presentation, and the like. In certain embodiments, the administration manager 113 provides a management interface (e.g., a dashboard) that can be used by an administrative user to provide information about content items, discounting information, licensing terms, editorial bundles, and the like.

Although the bundling techniques are herein described primarily with respect to the bundling of content items, the described techniques may also or instead be utilized with respect to other types of products or services. For example, the MMS may generate bundles of multiple related products, based on attributes or information associated with such products and/or the activities of one or more users, such as books having shared or similar attributes (e.g., author, subject, publisher), combinations of personal electronics goods that have been frequently purchased together (e.g., a portable music device together with headphones and a car charger), or the like. In some embodiments, related services may also be included or offered as part of a bundle. As one example, the MMS may include a discount or coupon for travel (e.g., an airfare discount, an offer for a resort stay, a car rental discount) along with a bundle that includes a travel guidebook.

The bundling techniques provided by example embodiments of the MMS can be used to provide bundles in various contexts, including in any kind of marketplace, such as a carrier marketplace (e.g., a telecom-provided marketplace), a carrier affiliate market (e.g., Android Market, GetJar, EA Mobile), an authorized third-party or “off-deck” merchant (e.g., Facebook, MySpace), a retail partner (e.g., Target, Wal-Mart), a point-of-sale system (e.g., NFC, Bluetooth, 2D/3D barcodes), or the like. Furthermore, although the bundling techniques are commonly described herein with respect to a “marketplace,” the techniques are equally applicable to any system, facility, or environment that facilitates transactions for goods and/or services, including an e-commerce site, an online storefront, a Web store, an Internet retailer, a “bricks and mortar” store, a barter and exchange system, and the like. Generally, the bundling techniques can be used by, or provide benefits to, various entities, including mobile carriers (e.g., who sell ringtones or other types of content), bricks and mortar and/or online retail companies (e.g., who sell bundles of goods or services via the facility), media and entertainment companies, financial services companies (e.g., investment firms that wish to provide bundles of financial information), and the like.

In addition, different architectures than the one shown in FIG. 1 may be used in other embodiments. In particular, one or more of components 111, 112, 113, and 118 may be operated by distinct entities. For example, the marketplace manager 112 may be operated by a third party, such as a carrier 161 (e.g., telecom or cellular company) or e-commerce system (e.g., an online store). As another example, the bundling manager 111 may be operated by one of the content providers 160.

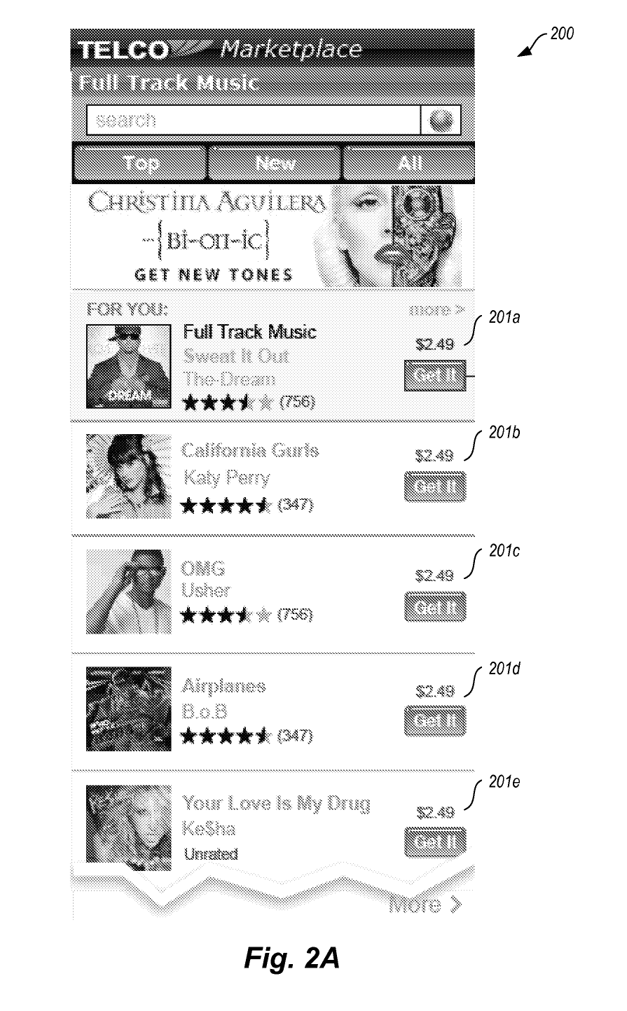

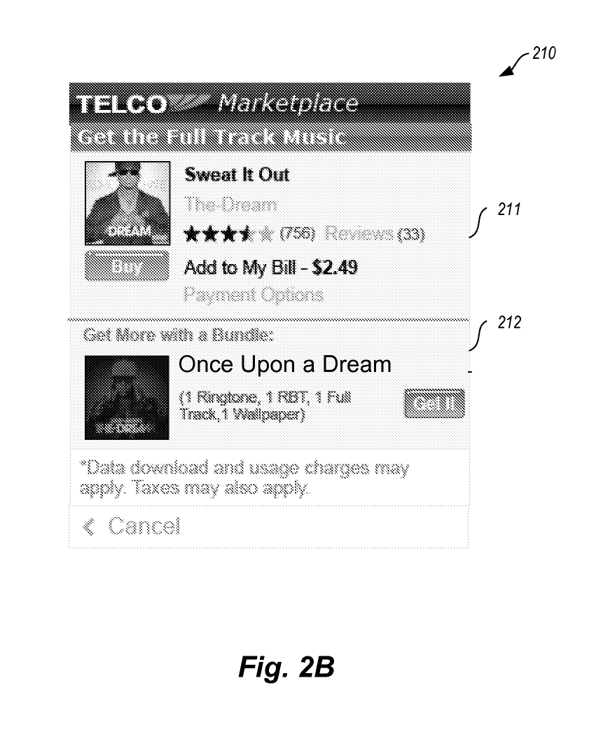

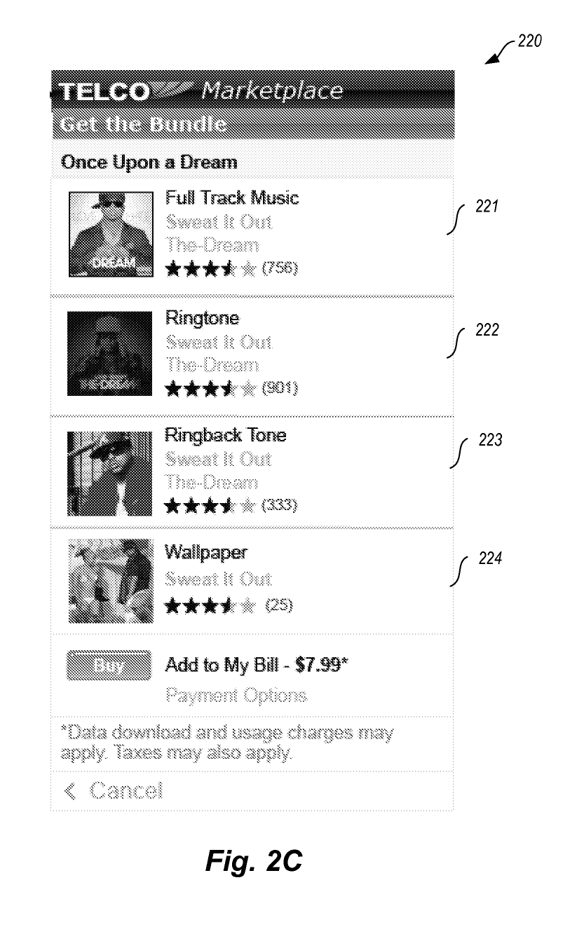

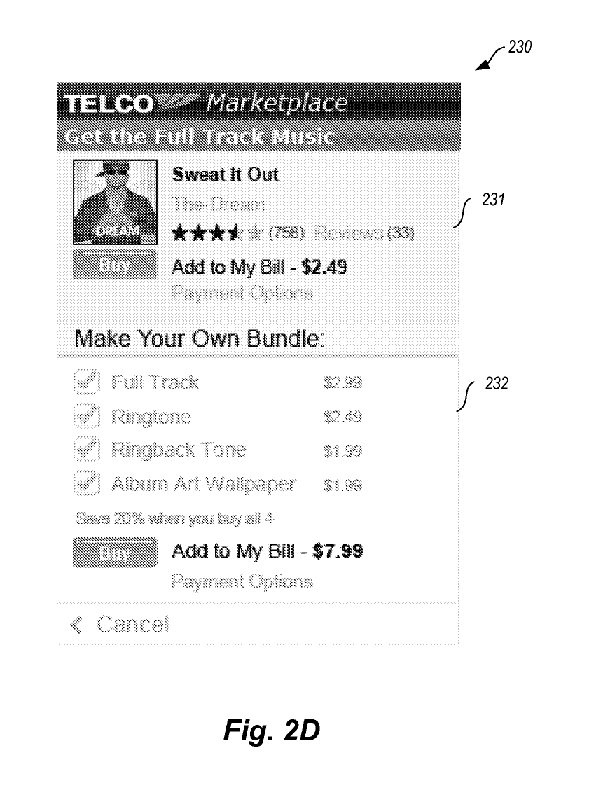

FIGS. 2A-2D illustrate mobile device screen displays provided by an example embodiment. More particularly, FIGS. 2A-2D provide a running example in which a user browses and selects a content item for purchase, and in response, is presented with a bundle that includes the selected content item along with other related content items.

FIG. 2A illustrates a “catalog” screen 200 that can be used by a user to obtain information about content items that are available for purchase via the mobile marketplace. The screen 200 includes multiple content item sections 201a-201e. Each section 201a-201e displays information about one content item that is available for purchase. The displayed information includes an image (e.g., album cover, artist image), song name, artist name and price. Each section 201a-201e also includes a control (labeled “Get It”) that, when selected by the user, initiates display of a transaction screen, as described with reference to FIG. 2B.

FIG. 2B illustrates a transaction screen 210 that presents information about a selected content item along with an indication of a related content bundle. In this example, the user has selected the song “Sweat It Out” displayed in section 201a of FIG. 2A, and in response, screen 210 has been displayed. Screen 210 includes sections 211 and 212. Screen 210 displays, in section 211, additional information and controls related to the selected content item, such as a rating, reviews, payment information, and a purchase control (e.g., a “Buy” button). In addition, screen 210 displays, in section 212, information about a content bundle that includes the selected content item. Section 212 also includes a control (labeled “Get It”) that, when selected by the user, initiates display of a bundle details screen, described with reference to FIG. 2C.

FIG. 2C illustrates a bundle details screen 220 that is used to present information about the contents of a selected bundle. Screen 220 displays information about the content items that are included in a selected bundle, such as a full track of music 221, a ringtone 222, a ringback tone 223 and a wallpaper image 224. Other types or forms of content items are contemplated including videos, interviews, editorial reviews, games, applications (e.g., “apps” for mobile devices), interactive media items (e.g., Flash modules/components), and the like. Content items may be represented in various data formats, including as audio data, video data, textual data, markup languages (e.g., HTML), computer instructions (e.g., for interactive content), and the like. Screen 220 also includes a purchase control (labeled “Buy”) that the user can select to initiate a purchase of the selected content bundle. Upon selecting the purchase control, the MMS transfers the selected content bundle to the user's mobile device, and takes appropriate billing actions, such as adding an amount to the user's monthly account, charging a credit card, deducting a number of points or credit from a subscription club, or the like.

FIG. 2D illustrates a bundle configuration screen 230 that can be used by a user to configure a selected bundle. In some embodiments, the screen 230 may be displayed in response to a user selection of a bundle, for example, as an alternative to screen 220 (FIG. 2C). The screen 230 includes sections 231 and 232. Section 231 provides information about a content item, such as artist name, song name, and the like. In this case, section 231 is displaying information (e.g., name, image, price, reviews) about a song named “Sweat It Out.” Section 232 provides information and controls related to a content bundle that includes the displayed content item of section 231. In particular, a user can use the controls (e.g., check boxes) of section 232 to customize or configure the contents of a content bundle. Section 232 also indicates the total bundle price (“$7.99”) as well as the amount of discount that is applied for a bundle purchase (“Save 20% when you buy all 4”). As noted, content bundle generation may also include the automatic determination of prices and discounts based on pricing information associated with the items of a content bundle. The displayed discount may thus increase or decrease based on the number and type of items in the content bundle, thereby providing the user with an interactive understanding of the benefits of purchasing content items in a bundle.

In some embodiments, the screens and user interface elements shown in FIGS. 2A-2D are defined or implemented using a mark-up language (e.g., HTML, WML, XHTML) and then rendered on a mobile computing device, such as a smart phone or feature phone. Other techniques may be used to implement the above-described user interface elements, including interactive multimedia platforms (e.g., Flash), native executables (e.g., device- or platform-specific “apps” that are made available in an app store or other repository), or the like.

The screens and user interface elements shown in FIGS. 2A-2D can be configured in various ways, such as via the administration manager 113 or some other component. In one embodiment, different bundle types (e.g., editorial, linked, relevancy) bundles can be assigned priorities, such that one type of bundle is displayed prior to another type of bundle. Also, a maximum number of bundles to display may be specified globally and/or for each of the different bundle types.

FIGS. 3A-3C illustrate example data processed, utilized, or generated by an example embodiment. More particularly, FIGS. 3A-3C each illustrate data structures that may be stored or otherwise represented by an example mobile marketplace system, and used to generate content bundle, determine prices, and/or assure compliance with license terms.

FIG. 3A depicts a data structure used by an example embodiment to represent information about content items. In particular, FIG. 3A depicts a table 300 comprising rows 302a-302f that each represents information about a content item. Each row includes multiple fields or attributes, including item identifier (“ID”) 301a, title 301b, artist 301c, type 301d, genre 301e, provider identifier (“ID”) 301f, base price 301g, and discount 301h. A greater or lesser number of fields/attributes may be represented in other embodiments.

As noted, some embodiments generate linked bundles based on attributes or other information related to content items. In the illustrated embodiment, linked bundles may be generated based on information found in fields 301a-301g, and particularly in fields 301a-301f. For example, linked bundles may be generated based on content items having at least one shared attribute, such as artist 301c or genre 301e. Such an embodiment may accordingly generate bundles such as: a bundle consisting of “First Song” (row 302a) and “Second Song” (row 302b), as both these content items have the same genre (Rap); a bundle consisting of “Sad Song” (row 302c) and “Rock Song” (row 302d), as both these content items are by the same artist (BBB); or the like.

Some embodiments may provide a bundling rules engine and/or other mechanism/facility for controlling the kinds or types of bundles that are to be generated. In one embodiment, a user may specify bundling rules that include one or more conditions, possibly connected by logical operators (e.g., AND, OR, NOT, IF), under which bundles are to be generated. Example conditions could include the minimum or maximum bundle size, the types of attributes that should be matched, or the like. One example rule may result in the generation of bundles having at least two, and no more than five, content items by the same artist. Another example rule may result in the generation of bundles of a specified size including items that are all the same genre and that are all Top-40 hits. Such rules may then be executed or evaluated by the mobile marketplace system, possibly when certain user-specified conditions are met, such as on a daily basis, whenever new content items are added, or the like.

The process of bundle generation can be configured in various ways, such as via the administration manager 113 or some other component. In one embodiment, a maximum bundle size can be specified for different bundle types (e.g., editorial, linked, relevancy). Also, popularity or user ratings may be considered when generating bundles, such as by selecting more highly rated content items for a bundle when there are more content items than a specified maximum number available for the bundle.

In addition, the mobile marketplace system may automatically determine bundle prices based on pricing information, such as that shown in fields 301g and 301g, associated with content items. For example, if a bundle consisting of “First Song” and “Second Song” is created, then a discount based on the discount field 301h of rows 302a (20%) and/or 302b (25%) may be applied. Different approaches are contemplated for determining an overall discount based on possibly different discount information associated with multiple content items. In one embodiment, the smallest percentage discount is used. Thus, for the example bundle above, a 20% discount is applied to the aggregate price of $1.98 (the sum of the base price field 301g for rows 302a and 302b), resulting in a discounted price of $1.58. In another embodiment, field 301h represents a maximum discount, such that an initial discount is computed based on some fraction (e.g., one-half) of the smallest percentage discount. Such an approach would result in an initial 10% discount being applied, based on the 20% discount found in row 302a. Such a discount may then grow or shrink based on various factors, including whether specific bundles are selling well, whether specific users are frequent purchasers of bundles, or the like. In yet other embodiments, field 301h represents an initial discount, and some other field (not shown) a maximum discount. In general, discount information may be combined in various ways, such as by using an average (mean), median, maximum, minimum, or the like. Price determination may also be at least in part user-specified, such as via bundling rules (above) or some other technique.

Discounting can be controlled or specified in other ways. For example, an overall discount level can be specified on a per-bundle size basis, such as a 10% discount for a bundle of size three, a 15% discount for a bundle of size four, a 25% discount for a bundle of size five, and so on. Such overall discount levels can then be specified to interact in various ways with per-item or per-provider discounts. For example, deeper discounting of individual content items may be allowed such that overall bundle discounts can be achieved. In one example embodiment, if one or more items in a bundle have a maximum discount that is less than the configured discount for the number of items in the bundle then the other items in the bundle may be discounted beyond the maximum configured discount for the bundle to force a total bundle discount equal to the maximum. For example, in a four item bundle that is configured to have a 20% overall discount, having one item with a 10% maximum discount, the 20% overall discount may be achieved by adhering to the 10% discount for the one item and discounting the other items more than the specified 20%.

As another example, less than full discounting may also or instead be allowed. In one example embodiment, the resulting overall bundle discount may be less than the specified overall bundle discount if one or more items in a bundle have a maximum discount less than the configured overall discount for the bundle. For example, in a four item bundle that is configured to have a 20% overall discount and having one item with a 10% maximum discount, a less than 20% overall discount may result by adhering to the 10% discount for the one item, and discounting the other items the specified 20%.

FIG. 3B depicts a data structure used by an example embodiment to represent licensing information associated with content providers. In particular, FIG. 3B depicts a table 310 comprising rows 312a-312g that each represents information about a content provider. Each row includes multiple fields or attributes, including provider identifier (“ID”) 311a and a license type 311b. A greater or lesser number of fields/attributes may be represented in other embodiments.

The illustrated information of table 310 is used by some embodiments to assure that generated bundles comply with licensing requirements or other types of safeguards or bundling conditions. Each row of the table 310 associates a content provider 311a with a corresponding license type 311b. Example license types include NEVER_BUNDLE (e.g., never generate any bundles using content provided by the corresponding provider), SAME_PROVIDER (e.g., only include content items provided by the corresponding provider in a bundle), ANY_PROVIDER (e.g., freely include content items from other content providers), SAME_GENRE (e.g., only generate bundles with content items of the same genre), SAME_ARTIST (e.g., only generate bundles with content items from the same artist), SAME_TYPE (e.g., only generate bundles with content items of the same type), and the like. In addition, license types may be combined, such as is illustrated in rows 312f and 312g. Row 312f specifies that bundles for the corresponding provider (ID 224) will only include content from that provider (SAME_PROVIDER) and content items of the same type (SAME_TYPE). Similarly, row 312g specifies that bundles for the corresponding provider (ID 667) will only include content from that provider (SAME_PROVIDER) and content items of the same genre (SAME_GENRE). Other license restrictions, types, or safeguards are contemplated, as well as other techniques for combining them.

FIG. 3C depicts a data structure that can be used to combine information such as that illustrated in FIGS. 3A and 3B, above. In particular, FIG. 3C depicts a table 320 comprising rows 322a-322f that each represent information about a content item via fields 321a-321h that are respectively similar to fields 301a-301h of table 300 (FIG. 3A). Table 320 differs from table 300 in that table 320 includes field 321i, which specifies a license type for each content item. The license types are similar to those described with reference to FIG. 3B, except that here they are applied in a more fine-grained (per-item) manner. Thus, for example, the license type of ANY_PROVIDER in row 321b allows the song “First Song” to be bundled with items from any other provider; the license type of SAME_GENRE in row 322b specifies that the song “Second Song” should only be bundled with content items from the same genre; and the license type of NEVER_BUNDLE in row 322c specifies that the song “Sad Song” should never be bundled with any other content items.

In certain embodiments, compliance with license safeguards may also be based on whether or not content items are (or are not) eligible for discounting. For example, a NO_DISCOUNT license term may be used to specify that a content item should not be placed in a bundle with items that are eligible for discounting.

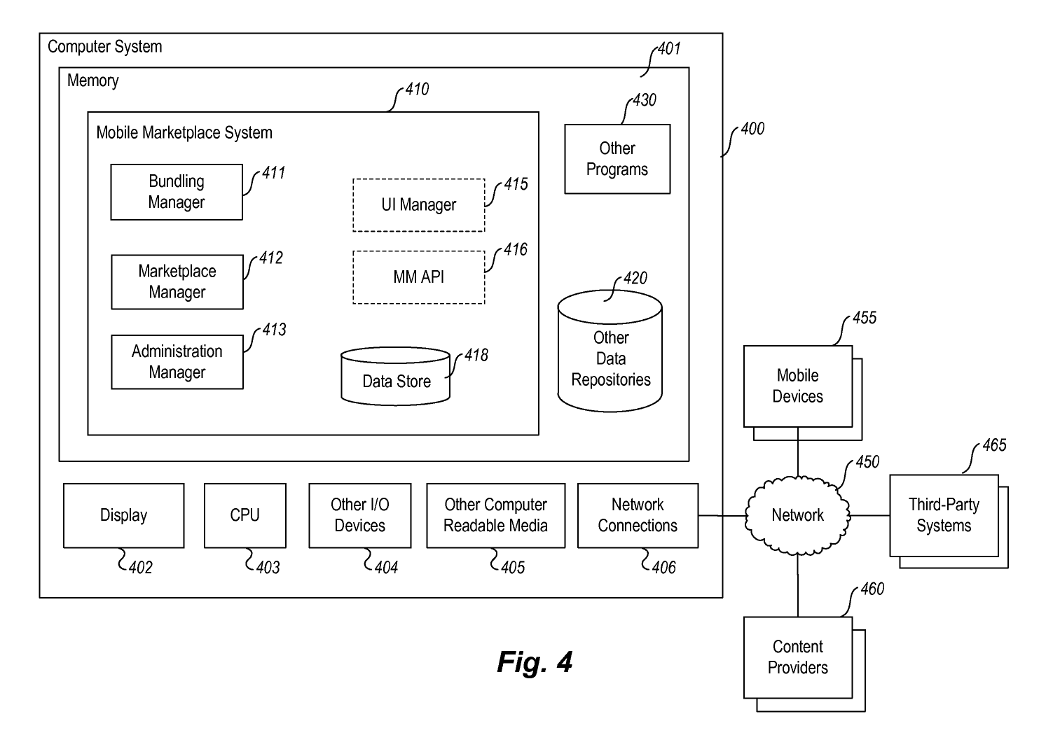

FIG. 4 is a block diagram of a computing system for implementing a mobile marketplace system according to an example embodiment. In particular, FIG. 4 shows a computing system 400 that may be utilized to implement a mobile marketplace system 410.

Note that one or more general purpose or special purpose computing systems/devices may be used to implement the mobile marketplace system 410. In addition, the computing system 400 may comprise one or more distinct computing systems/devices and may span distributed locations. Furthermore, each block shown may represent one or more such blocks as appropriate to a specific embodiment or may be combined with other blocks. Also, the mobile marketplace system 410 may be implemented in software, hardware, firmware, or in some combination to achieve the capabilities described herein.

In the embodiment shown, computing system 400 comprises a computer memory (“memory”) 401, a display 402, one or more Central Processing Units (“CPU”) 403, Input/Output devices 404 (e.g., keyboard, mouse, CRT or LCD display, and the like), other computer-readable media 405, and network connections 406 connected to a network 450. The mobile marketplace system 410 is shown residing in memory 401. In other embodiments, some portion of the contents, some or all of the components of the mobile marketplace system 410 may be stored on and/or transmitted over the other computer-readable media 405. The components of the mobile marketplace system 410 preferably execute on one or more CPUs 403 and manage subscriptions as described herein. Other code or programs 430 (e.g., an administrative interface, a Web server, and the like) and potentially other data repositories, such as data repository 420, also reside in the memory 401, and preferably execute on one or more CPUs 403. Of note, one or more of the components in FIG. 4 may not be present in any specific implementation. For example, some embodiments may not provide the other computer-readable media 405 or the display 402.

The mobile marketplace system 410 interacts via the network 450 with mobile devices 455, third-party systems 465, and content providers 460. The network 450 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. The third-party systems 465 may include, for example, systems operated by or for carriers, payment processors, online merchants, or the like. The mobile devices 455 include computing devices that generally carry or include their own power supplies (e.g., batteries), such as mobile phones, smart phones, feature phones, tablet computers, and the like. In other embodiments, other types of computers or computing devices can be used to interact with the mobile marketplace system 410, including desktop computers, tablet computers, embedded (e.g., automobile) computers, and the like.

In a typical embodiment, the mobile marketplace system 410 includes a bundling manager 411, a marketplace manager 412, an administration manager 413, a user interface (“UI”) manager 415, a mobile marketplace application program interface (“API”) 416, and a data store 418. The modules 411-413 respectively perform functions such as those described with reference to modules 111-113 of FIG. 1. The data store 418 performs functions and includes data similar to that described with reference to data store 118 of FIG. 2. The user interface manager 415 and MM API 416 are drawn in dashed lines to indicate that in other embodiments, functions performed by one or more of these components may be performed externally to the mobile marketplace system 410.

The UI manager 415 provides a view and a controller that facilitate user interaction with the mobile marketplace system 410 and its various components. For example, the UI manager 415 may provide interactive access to the mobile marketplace system 410, such that users can perform transactions, obtain content items including content bundles, initiate searches for content, and the like. In some embodiments, access to the functionality of the UI manager 415 may be provided via a Web server, possibly executing as one of the other programs 430. In such embodiments, a user operating a Web browser (or other type of client) executing on one of the mobile devices 455 can interact with the mobile marketplace system 410 via the UI manager 415.

The MM API 416 provides programmatic access to one or more functions of the mobile marketplace system 410. For example, the API 416 may provide a programmatic interface to one or more functions of the mobile marketplace system 410 that may be invoked by one of the other programs 430 or some other module. In this manner, the API 416 facilitates the development of third-party software, such as user interfaces, plug-ins, news feeds, adapters (e.g., for integrating functions of the mobile marketplace system 410 into Web applications), and the like. In addition, the API 416 may be in at least some embodiments invoked or otherwise accessed via remote entities, such as one of third-party systems 465, to access various functions of the mobile marketplace system 410. For example, a carrier operating as one of the third-party systems 465 may provide customer data (e.g., customer account information) to the mobile marketplace system 410 via the API 416.

The data store 418 is used by the other modules of the mobile marketplace system 410 to store and/or communicate information. The components of the system 410 use the data store 418 to record various types of information, including content, information about users, transaction information, and the like. Although the components of the system 410 are described as communicating primarily through the data store 418, other communication mechanisms are contemplated, including message passing, function calls, pipes, sockets, shared memory, and the like.

In an example embodiment, components/modules of the mobile marketplace system 410 are implemented using standard programming techniques. For example, the mobile marketplace system 410 may be implemented as a “native” executable running on the CPU 403, along with one or more static or dynamic libraries. In other embodiments, the mobile marketplace system 410 may be implemented as instructions processed by a virtual machine that executes as one of the other programs 430. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the described functions.

In addition, programming interfaces to the data stored as part of the mobile marketplace system 410, such as in the data store 418, can be available by standard mechanisms such as through C, C++, C#, and Java APIs; libraries for accessing files, databases, or other data repositories; through scripting languages such as XML; or through Web servers, FTP servers, or other types of servers providing access to stored data. The data store 418 may be implemented as one or more database systems, file systems, or any other technique for storing such information, or any combination of the above, including implementations using distributed computing techniques.

Different configurations and locations of programs and data are contemplated for use with the techniques described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions described herein.

Furthermore, in certain embodiments, some or all of the components of the mobile marketplace system 410 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored or otherwise represented as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and data structures may also be stored or represented as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Some or all of the system components and/or data structures may be stored as non-transitory content on a tangible computer-readable medium. Such computer program products may also take other forms in other embodiments. Accordingly, embodiments of this disclosure may be practiced with other computer system configurations.

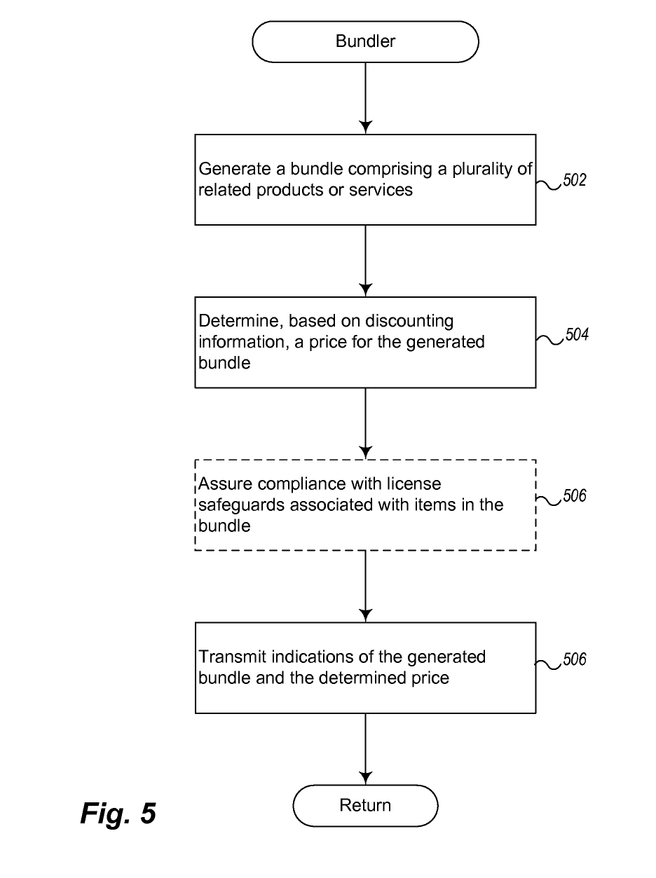

FIG. 5 is a flow diagram of a bundling process performed by an example embodiment. In particular, FIG. 5 illustrates a process that may be implemented by, for example, one or more elements of the mobile marketplace system 410 (or 100), such as the bundling manager 411 (or 111), described with reference to FIGS. 1 and 4. The process generates bundles each comprising a plurality of related products or services, such as content items, tangible products (e.g., books, electronic goods, clothing, toys), service functions (e.g., travel services, financial services), and the like.

The process begins at block 502, where it generates a bundle comprising a plurality of related products or services, such as content items. In the content bundling context, generating a content bundle may be attribute-based, such as by selecting content items based on shared or similar attributes, including artist/author, content provider, genre, type, ISRC code, or the like. In other embodiments, generating a content bundle may be based on information about activities of one or more users. For example, the bundle may be generated based on user purchase or browsing histories and/or explicit indications (e.g., “likes” and “dislikes”) of preferences for certain items or types of items. In one embodiment, co-occurrences of purchases (even if temporally separated) can be used to identify items to include in a bundle. For example, two songs may be bundled together if users who have bought the first of the two songs are also likely to have bought the second of the two songs.

At block 504, the process determines, based on discounting information, a price for the generated bundle. In certain embodiments, the determined price will be less than the sum of the separate purchase prices for the items in the bundle. Discounting information may include one or more of: initial/minimum/maximum prices; initial/minimum/maximum discounts (e.g., expressed in absolute amounts or percentages); the number of items in the bundle; and the like. Also, or instead, a discounted price may be determined by user-related factors, such as how frequently or recently a user has purchased a bundle. In such cases, lower prices may be provided to either entice a user to purchase a bundle and/or to reward a user for frequent bundle purchases.

At block 506, the process optionally assures compliance with license safeguards associated with items in the bundle. In some embodiments, assuring compliance with license safeguards includes determining whether license terms associated with items indicate whether or not the items are allowed to be included in the bundle. License terms or information may indicate various conditions under which an item may or may not be included in a bundle, such as by indicating that the item can or cannot be added to any bundle and/or by indicating that the item cannot be added to a bundle containing items from other providers, from other artists, of other genres, of other types, or the like.

At block 508, the process transmits indications of the generated bundle and the determined price. Transmitting the indications includes transmitting the indications to a computing device operated by a user. In other embodiments, the indications may be instead transmitted to an intermediary computing system (e.g., a third-party e-commerce computing system that manages its own online marketplace), which in turn provides them to end users.

The above process may be initiated in various ways. In some embodiments, the process runs in an on-demand manner, such as in response to an indication that a user is viewing information about a particular item. The process can then be executed to generate a bundle that includes the viewed item. In other embodiments, the process runs in “batch” or “bulk” mode, in which it is executed repeatedly to create multiple bundles. For example, the process may run nightly to create bundles that include indications of items that are newly received from one or more providers. The process may be executed upon the occurrence of other conditions, including upon the receipt of information about items, upon expiration of a time interval, or the like.

Other embodiments may perform the above-described operations in a different order, or leave out some operations entirely. For example, price determination (block 504) may be performed after license assurance (block 506). Also, in some embodiments, price determination (block 504) does not include discounting, and bundle prices are instead calculated as a simple sum of the prices of individual items in a bundle.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “includes,” “including,” “comprises,” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A computer-implemented method, comprising in a computing system, facilitating distribution of dynamically generated content bundles to users in a mobile marketplace, by:
generating a content bundle available for purchase by a user, the content bundle comprising a plurality of related content items;
determining, based on discounting information associated with at least one of the plurality of related content items, a price for the generated content bundle that is less than a sum of individual prices of each of the plurality of related content items; and
transmitting indications of the generated content bundle and the determined price.

2. The method of claim 1, further comprising:
receiving an indication that the user is currently viewing information about one of the plurality of related content items; and
in response to the received indication, generating the content bundle to include the one content item.

3. The method of claim 1 wherein generating the content bundle includes selecting the plurality of related content items for inclusion in the bundle based on an attribute that is shared between content items of the bundle.

4. The method of claim 3 wherein the attribute includes one of: a title of a content item, an artist associated with a content item, an album that includes a content item, a genre of a content item, a type of a content item, a content provider of a content item, and an International Standard Recording Code of a content item.

5. The method of claim 1 wherein generating the content bundle includes selecting the plurality of related content items for inclusion in the bundle based on information about activities of one or more users.

6. The method of claim 5 wherein selecting the plurality of related content items includes selecting content items based on information about activities of the user, including at least one of: a purchase history associated with the user, indications of likes or dislikes received from the user, and a browsing history associated with the user.

7. The method of claim 5 wherein selecting the plurality of related content items includes selecting content items based on information about activities of other users.

8. The method of claim 7 wherein selecting content items includes selecting a first and second content item based on an indication that at least some of the other users purchased both the first and second content item.

9. The method of claim 1 wherein determining the price for the generated content bundle is based on at least one of: a minimum price for a content item of the bundle, an initial price for a content item of the bundle, a maximum discount that can be applied to a content item of the bundle, and an indication that no discount is allowed for a content item of the bundle.

10. The method of claim 1 wherein determining the price for the generated content bundle is based on information about activities of the user, including whether or not the user has previously purchased a content bundle.

11. The method of claim 1, further comprising assuring compliance with license terms associated with one of the content items of the bundle, by determining whether or not the license terms associated with the one content item indicate whether or not the content item can be included in the bundle.

12. The method of claim 11 wherein assuring compliance includes determining that a content item can or cannot be included in the content bundle due to license terms that specify conditions under which the content item can or cannot be included in content bundles, the specified conditions indicating acceptable content providers, genres, artists, and/or types.

13. The method of claim 11 wherein assuring compliance includes determining that a content item cannot be included in the content bundle because license terms associated with the content item indicate at least one of:
the content item cannot be added to any bundles;
the content item cannot be added to any bundles that include content items from content providers other than a content provider that provided the content item;
the content item cannot be added to any bundles that include content items of a genre other than a genre associated with the content item; and
the content item cannot be added to any bundles that include content items from an artist other than an artist associated with the content item.

14. A computer-readable medium whose contents enable a computing system to provide bundles in a marketplace, by performing a method comprising:
facilitating distribution of dynamically generated bundles to users in a marketplace, by:
generating a bundle available for purchase by a user, the bundle comprising a plurality of related items;
determining, based on discounting information associated with at least one of the plurality of related items, a price for the generated bundle that is less than a sum of individual prices of each of the plurality of related items; and
transmitting indications of the generated bundle and the determined price.

15. The computer-readable medium of claim 14 wherein the method further comprises receiving information about content items from multiple distinct content providers, and wherein the generated bundle is a content bundle that includes at least some of the content items.

16. The computer-readable medium of claim 14 wherein the method further comprises:
receiving an indication that the user desires to purchase the generated bundle;
transmitting the generated bundle to a mobile device operated by the user; and
facilitating payment for the indicated bundle.

17. The computer-readable medium of claim 14 wherein transmitting indications of the generated bundle and the determined price includes transmitting the indications to a browser program executing on a mobile device operated by the user.

18. The computer-readable medium of claim 14 wherein the contents are instructions that when executed cause the computing system to perform the method.

19. A computing system configured to provide dynamically generated bundles in a marketplace, the system comprising:
a memory; and
a bundle generation module that is stored on the memory and that is configured, when executed, to facilitate distribution of dynamically generated bundles to users in a marketplace, by:
generating a bundle available for purchase by a user, the bundle comprising a plurality of related items;
determining, based on discounting information associated with at least one of the plurality of related items, a price for the generated bundle that is less than a sum of individual prices of each of the plurality of related items;
assuring compliance with license terms associated with each of the items of the bundle; and
transmitting to a computing device operated by the user indications of the generated bundle and the determined price.

20. The system of claim 19 wherein the related items include content items that are each at least one of: a song, a ringtone, a ringback tone, an image, a wallpaper image, a video text, a game, an application for a mobile device, and an interactive media item.

21. The system of claim 19, wherein the marketplace is a mobile marketplace, and further comprising a marketplace manager configured to provide information about items available via the mobile marketplace to mobile devices.

22. The system of claim 19 wherein the bundle generation module is configured to provide bundle generation services to a remote third-party system that hosts the marketplace.

23. The system of claim 19 wherein the computing device is one of: a personal digital assistant, a smart phone, a laptop computer, a features phone, a quick messaging device, a multimedia phone, a netbook computer, a tablet computer, and/or a home automation device.

24. The system of claim 19, further comprising an administration module configured to control operation of the bundle generation module by:
providing a management interface to an administrative user;
receiving, via the management interface, the discounting information;
receiving, via the management interface, indications of the licensing terms; and
receiving, via the management interface, indications of editorial bundles to be provided by the bundle generation module.

25. The system of claim 19 wherein the bundle generation module includes software instructions for execution in the memory of the computing system.
